(19) United States
(12) Patent Application Publication
(10) Pub. No.: US 2010/0026455 A1
(43) Pub. Date: Feb. 4, 2010

(54) Device and Method for Reducing Peak Current Demands In a Mobile Device

(76) Inventors: Russell Calvarese, Stony Brook, NY (US); William Sakoda, East Setauket, NY (US)

Correspondence Address: MOTOROLA, INC., 1303 EAST ALGONQUIN ROAD, IL01/3RD, SCHAUMBURG, IL, 60196, US

(21) Appl. No.: 12/182,661

(22) Filed: Jul. 30, 2008

(51) Int. Cl. H04Q 5/22

(52) U.S. Cl. 340/10.1

(57) ABSTRACT

A device may include a battery; a first component drawing a first current from the battery, the first current being below a threshold; and a second component drawing a second current from the battery. The second component indicates the entering of a low current mode for a predetermined time. The first component is allowed to draw a third current above the threshold for the predetermined time.

### BACKGROUND

The operational parameters of handheld devices are often governed by available battery power. While average current demands are often low, peak current demand may be significantly higher. Both average and peak current may factor into the selection of a battery. Because the size and weight of a device may be significantly impacted by the size and weight of its battery, maintaining peak current at or below a certain level may enable such size and weight to be minimized.

### SUMMARY OF THE INVENTION

The present invention relates to a device and a method for reducing peak current demands in a mobile device. The device may include a battery; a first component drawing a first current from the battery, the first current being below a threshold; and a second component drawing a second current from the battery. The second component indicates the entering of a low current mode for a predetermined time. The first component is allowed to draw a third current above the threshold for the predetermined time.

### BRIEF DESCRIPTION OF THE DRAWINGS

FIG. 1 shows a schematic view of an exemplary mobile computing device according to the present invention.

FIG. 2 shows a graph of current usage against time for an exemplary device according to the present invention.

FIG. 3 shows an exemplary method according to the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe systems and methods for minimizing the peak current requirements of a mobile computing device that includes more than one current-drawing component.

FIG. 1 shows a schematic layout of an exemplary mobile computing device 100 according to the present invention. The device 100 may include a battery 110, a CPU 120, an RFID radio 130 and a WLAN radio 140. Those of skill in the art will understand that the device 100 may typically include other components (e.g., a display, a user input means, a USB interface, a speaker, etc.) that are not shown in FIG. 1. Further, those of skill in the art will understand that the presence of an RFID radio 130 and a WLAN radio 140 is only exemplary, and that the current requirements to be managed by the exemplary embodiments may be due to various other types of components.

The battery 110 may be any type of battery capable of storing electric energy for use by the components of the device 100, including the CPU 120, the RFID radio 130 and the WLAN radio 140. The battery 110 may be reusable or disposable. In one exemplary embodiment, the battery 110 is a lithium ion rechargeable battery. The CPU 120 may be any processing unit known in the art and suitable for operating a mobile computing device such as the device 100. The RFID radio 130 may be coupled with the CPU 120 and an antenna (not shown) to enable RFID communication with other devices, and the WLAN radio 140 may similarly be coupled with the CPU 120 and a further antenna (not shown) to enable WLAN communication with other devices. Each of the RFID radio 130 and the WLAN radio 140 may coordinate communications using any of various communications protocols known in the art.

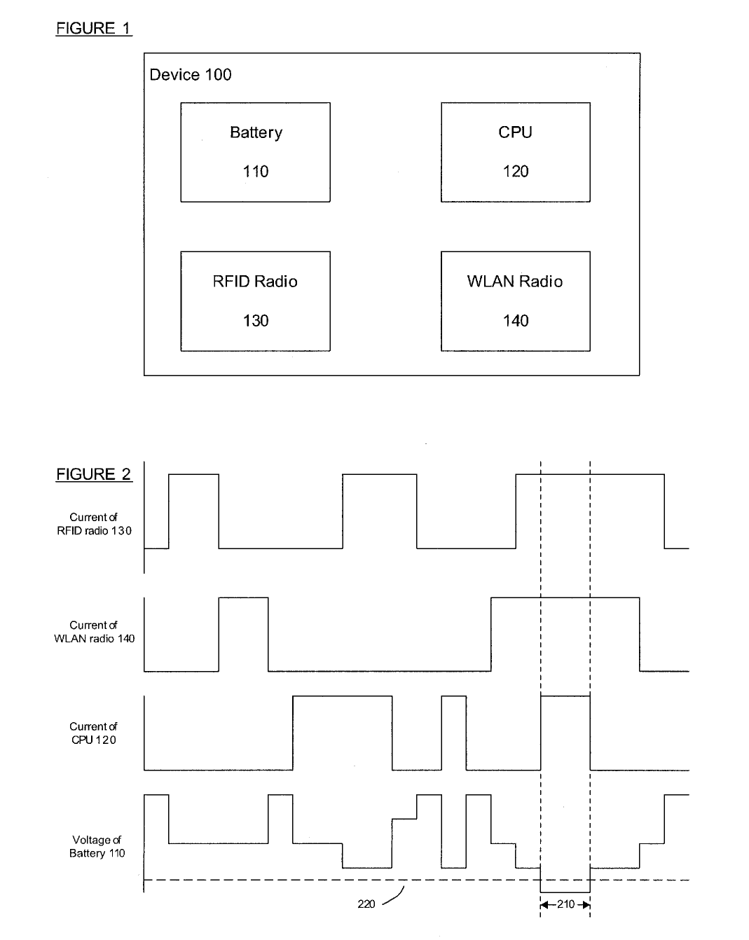

FIG. 2 illustrates an exemplary graph showing the power consumption of the CPU 120, the on-off status of the RFID radio 130 and the WLAN radio 140, and the voltage of the battery 110 with respect to time. It should be noted that the CPU power consumption and the component on-off status are only exemplary and have been selected to illustrate the problem to be addressed by the exemplary embodiments. Those of skill in the art will understand that battery voltage as shown in FIG. 2 may depend on factors including the internal impedance of the battery 110, the temperature of the environment in which the device 100 is being used, and the current demands of the CPU 120, the RFID radio 130 and the WLAN radio 140 as illustrated.

FIG. 2 illustrates that when multiple components are demanding high levels of current simultaneously, the voltage of the battery 110 may drop below a critical threshold level. When this happens, the device 100 may shut down due to under voltage. For example, in time interval 210, the CPU 120, the RFID radio 130 and the WLAN radio 140 are all drawing high amounts of current. As a result, the voltage of the battery 110 may drop below a threshold level 220, and the device 100 may shut down. Those of skill in the art will understand that FIG. 2 is only intended to indicate qualitatively the effect that the current demands of the various components may have on the voltage of the battery 110, and that no precise quantitative current or voltage measurements are indicated, because these will depend on the individual device and its components.

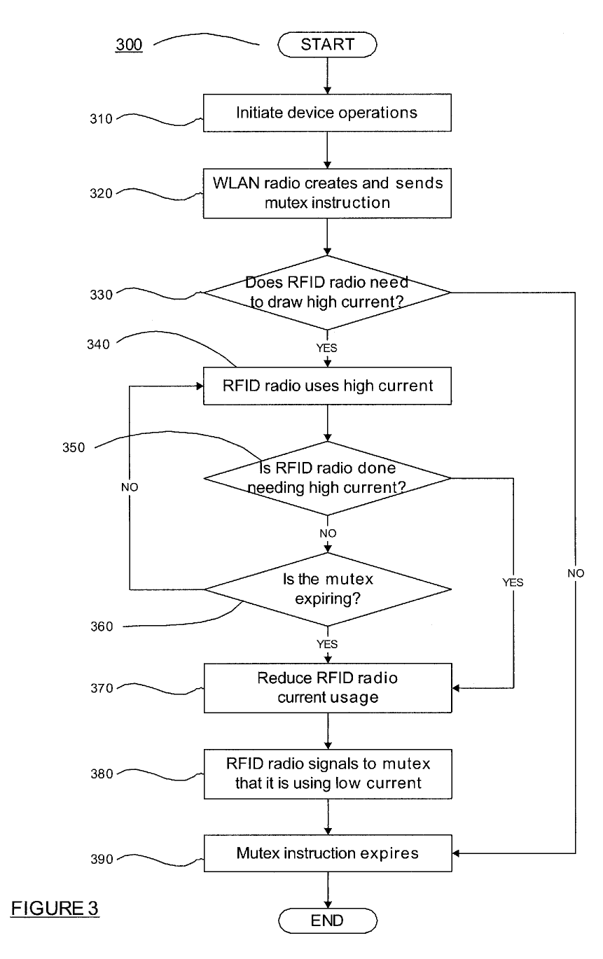

FIG. 3 illustrates an exemplary method 300 for reducing the peak current demands of a mobile device such as the device 100 of FIG. 1. The method 300 is described herein specifically with reference to the components of the exemplary device 100; however, those of skill in the art will understand that the same principles may apply to various other types of battery-powered devices. In step 310, the operations of the device 100 are initiated. This step may include powering on the CPU 120, initiating an operating system, powering on the RFID radio 130 and the WLAN radio 140, etc. Further, device initiation may include instructing the RFID radio 130 that it must maintain the amount of current that it draws below a threshold level unless it is otherwise instructed. The threshold level may be determined as a function of the capacity of the battery 110 and the current needs of the CPU 120 and the WLAN radio 140; in one embodiment, the threshold current is selected such that when the CPU 120 and the WLAN radio 140 are drawing their maximum possible current and the RFID radio 130 is drawing the threshold current, the voltage of the battery 110 is maintained above a critical level (e.g., a shutdown threshold, a threshold selected to maximize battery life, etc.). Alternately, based on factors such as impedance or remaining capacity, it may be determined whether the RFID radio 130 may need to be shut down.

Following step 310, the device may operate within normal parameters as described above (e.g., with the RFID radio 130 not drawing high current draw below the threshold level) until step 320. In step 320, the WLAN radio 140 creates and signals, to the RFID radio 130, a mutual exclusion (“mutex”) instruction indicating that the WLAN radio 140 will not draw high current for some specified time interval. This further indicates that the RFID radio 130 may draw high current during that time interval. It should be noted that the WLAN radio 140 may communicate directly or indirectly with the RFID radio 130. For example, the mutex may be a software function executed by the CPU 120, which may signal permission to draw high current by the RFID radio 130.

In step 330, the RFID radio 130 determines whether it needs to increase the current it is drawing beyond the threshold value (e.g., to increase the range of its communications, to make its signals more distinct from background noise, etc.). If a higher current draw is needed, then in step 340 the RFID radio 130 increases the current that it is drawing from the battery 110. Because the WLAN radio 140 is drawing lower current during the time interval permitted by the mutex, the increased draw by the RFID radio 130, even coupled with high current draw by the CPU 120, does not cause the voltage of the battery 110 to drop to problematic levels.

In step 350, the RFID radio 130 determines whether it has completed the operations that require it to draw high current. If the RFID radio 130 still needs to draw high current, it determines in step 360 whether the time interval signaled by the mutex is expiring. If the mutex is not expiring, and thus the RFID radio 130 is able to continue to draw high current, the method returns to step 340, where high current operations continue. However, if the RFID radio 130 determines in step 350 that it no longer requires high current, or determines in step 360 that the mutex is expiring, then it reduces its current draw back to below its original threshold value in step 370. Those of skill in the art will understand that the determinations of steps 350 and 360 should be made continuously while the RFID radio 130 is drawing high current; for example, they may be made regularly at set time intervals.

After the RFID radio 130 reduces its current usage in step 370, in step 380 it signals the mutex to indicate that it has done so. Subsequently, in step 390 the mutex expires and the operations of the device 100 return to the state in which they existed prior to the initiation of the permission-granting in step 320. Alternately, if the RFID radio 130 never determines, in step 330 during the duration of the mutex, that it needs to draw a high level of current, then steps 340 to 380 are never performed, and the method simply proceeds directly to step 390, where the mutex expires.

As discussed above, the use of an RFID radio 130 and a WLAN radio 140 is only exemplary. In other embodiments, the RFID radio 130 may be replaced by a laser scanner, an imager, a WWAN radio, or any other component that may have its current usage limited in order to insure proper device performance. Similarly, the WLAN radio 140 may be replaced by another component that may periodically enter a low current mode at its discretion in order to enable to RFID radio 130 (or similar component) to use more current.

By the implementation of the above-described exemplary embodiments, the battery 110 may be maintained at a safe voltage level without implementing a software or hardware solution to monitor the current usage of various components. Rather, once the battery has been selected and the threshold values have been defined, the components of the system 100 may communicate with one another, using a simple process, to insure safe battery levels.

In an alternative exemplary embodiment, a mobile device may include two radios that both have their current draw limited to below predetermined thresholds when the device is in a default state. These thresholds may be determined based on any of the factors discussed above for previously-described embodiments. In such an embodiment, either of the two radios may have the capability to grant permission to the other radio, via mutex, to draw current above the predetermined threshold for a specified time period. The same principle may be applied to devices with more than two components that have their current draw limited in this manner.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

What is claimed is:

1. A device, comprising:
a battery;
a first component drawing a first current from the battery, the first current being below a threshold; and
a second component drawing a second current from the battery, the second component indicating the entering of a low current mode for a predetermined time, the first component being allowed to draw a third current above the threshold for the predetermined time.

2. The device of claim 1, wherein the first component is one of an RFID transceiver and a laser scanner.

3. The device of claim 2, wherein the second component is one of a CPU and a WLAN transceiver.

4. The device of claim 1, wherein the drawing of the first current and the second current maintains a voltage of the battery above a voltage threshold and the drawing of the third current and the drawing of the third current and the second current maintain the voltage of the battery above the voltage threshold.

5. The device of claim 4, wherein the voltage threshold is a shutdown threshold.

6. The device of claim 1, wherein the second component indicates the entering of the low current mode by sending a mutex instruction.

7. The method of claim 6, further comprising:
a processor receiving the mutex instruction from the second component and sending the mutex instruction to the first component.

8. The method of claim 7, wherein the first component receives the indication of the low current mode and determines whether to draw the third current above the threshold.

9. The device of claim 1, wherein the second current is below a further threshold, and wherein the first component indicates the entering of a low current mode for a further predetermined time, the second component being allowed to draw a fourth current above the further threshold for the further predetermined time

10. A method, comprising:
drawing, by a first component, a first current below a predetermined threshold;
indicating, by a second component, the entering of a low power mode for a predetermined time; and
drawing, by the first component, a second current above the threshold for a portion of the predetermined time.

11. The method of claim 10, wherein the first component is one of an RFID radio and a laser scanner.

12. The method of claim 11, wherein the second component is one of a WLAN radio and a processor.

13. The method of claim 10, wherein the drawing of the first current and the second current maintains a voltage of a battery above a voltage threshold.

14. The method of claim 13, wherein the voltage threshold is a shutdown threshold.

15. The method of claim 10, wherein the second component indicates the entering of the low current mode by sending a mutex instruction.

16. The method of claim 15, further comprising:
receiving, by a processor, the mutex instruction from the second component; and
sending, by the processor, the mutex instruction to the first component.

17. The method of claim 10, further comprising:
reducing, by the first component, a current draw to the first current prior to the expiration of the predetermined time.

18. The method of claim 10, further comprising:
determining, by the first component, whether to draw the second current above the threshold.

19. A device, comprising:
a battery;
a first component including means for drawing a first current from the battery, the first current being below a threshold; and
a second component including means for drawing a second current from the battery, the second component further including means for indicating the entering of a low current mode for a predetermined time, the first component being allowed to draw a third current above the threshold for the predetermined time.

20. The device of claim 19, wherein the first component is one of an RFID transceiver and a laser scanner, and wherein the second component is one of a CPU and an WLAN transceiver.
